(19) United States
(12) Patent Application Publication
(10) Pub. No.: US 2012/0139978 A1
(43) Pub. Date: Jun. 7, 2012

(54) ORGANIC EL DISPLAY APPARATUS AND DRIVING METHOD OF THE SAME

(75) Inventor: Kouji Ikeda, Chiba-shi (JP)

(73) Assignee: CANON KABUSHIKI KAISHA, Tokyo (JP)

(21) Appl. No.: 13/302,047

(22) Filed: Nov. 22, 2011

(30) Foreign Application Priority Data
Dec. 2, 2010 (JP) 2010-269260

(51) Int. Cl. G09G 3/30; G09G 5/02

(52) U.S. Cl. 345/694; 345/77

(57) ABSTRACT

An organic EL display apparatus comprises a plurality of pixels, each having first and second sub pixels; an organic EL element provided for each sub pixel; a data line driver; a pixel circuit; and a gate line driver. Each pixel includes a first organic EL element arranged in a first sub pixel emitting light of the same color; and a second organic EL element arranged in a second sub pixel. The light-extraction efficiency of the second sub pixel is higher than that of the first sub pixel. At least one of a plurality of transistors applies a drive current. The reference voltage line driver supplies a reference voltage to a gate terminal of the drive transistor to perform gradation displaying on the first organic EL element at a light emitting level, and to perform gradation displaying on the second organic EL element by controlling the light emitting period.

### BACKGROUND OF THE INVENTION

1. Field of the Invention

The present invention relates to a display apparatus using an organic EL (electroluminescent) element and a driving method of the same, and more particularly to an active matrix type organic EL display apparatus capable of improving light use efficiency in the front direction of the organic EL element and a driving method of the same.

2. Description of the Related Art

The organic EL element allows light to be emitted at various angles from a light emitting layer thereof, thus increasing the production of light components fully reflected on an interface between a protection layer and an external space. Some of the fully reflected light components are confined inside the element. Accordingly, the organic EL element has a problem of lower light extraction efficiency. In order to solve this problem, Japanese Patent Application Laid-Open No. 2004-039500 discloses a micro lens array made of a resin provided on a silicon oxynitride (SiNxOy) film for sealing the organic EL element.

The configuration of providing a micro lens array on the organic EL element as disclosed in Japanese Patent Application Laid-Open No. 2004-039500 is expected to provide not only an effect of extracting the light components that would have been fully reflected if the micro lens array were not used, but also a light condensing effect. These effects can contribute to improvement in light extraction efficiency (particularly front side luminance) of the display apparatus using the organic EL element. Unfortunately, the improvement in light-extraction efficiency involves remarkable luminance variations and unevenness due to TFT variations at manufacturing that would not have been noticed before. Further, the luminance in an oblique direction of the display apparatus is reduced, and hence this configuration is not easy to use in a situation requiring wide view angle characteristics.

### SUMMARY OF THE INVENTION

It is an object of the present invention to provide an organic EL display apparatus capable of selecting between a “power save mode” and a “wide view angle mode” according to the user scene, capable of suppressing luminance variations and unevenness due to TFT variations and shading due to a voltage drop, and having high display image quality. In addition, it is another object of the present invention to provide a method of driving an organic EL display apparatus capable of suppressing luminance variations and unevenness due to TFT variations and shading due to a voltage drop and having high display image quality.

In order to achieve the above object, according to an aspect of the present invention, an organic EL display apparatus comprises: a plurality of pixels arranged in a matrix, each of the pixels including first and second sub pixels, each of the sub-pixels including an organic EL element; a data line drive circuit for supplying a data signal to the plurality of pixels; a plurality of pixel circuits each arranged in each of the plurality of pixels, and each of the pixel circuits including a drive transistor for controlling a current supplied to the organic EL element based on the data signal; and a reference voltage line drive circuit for supplying a reference voltage to the pixel circuit, wherein each of the plurality of pixels includes a first organic EL element arranged in the first sub pixel and a second organic EL element arranged in the second sub pixel, and the first and second organic EL elements emitting lights of the same color, a light-extraction efficiency of the second sub pixel is larger than the light-extraction efficiency of the first sub pixel, and the reference voltage line drive circuit supplies the reference voltage to a gate of the drive transistor, to control a light emitting level of the first organic EL element for gradation displaying, and to control a light emitting period of the second organic EL element for gradation displaying.

In order to achieve the above object, according to a further aspect of the present invention, a driving method of an organic EL display apparatus comprises a plurality of pixels arranged in a matrix, each of the pixels including first and second sub pixels, each of the sub-pixels including an organic EL element; a data line drive circuit for supplying a data signal to the plurality of pixels; a plurality of pixel circuits each arranged in each of the plurality of pixels, and each of the pixel circuits including a drive transistor for controlling a current supplied to the organic EL element based on the data signal; and a reference voltage line drive circuit for supplying a reference voltage to the pixel circuit, wherein each of the plurality of pixels includes a first organic EL element arranged in the first sub pixel and a second organic EL element arranged in the second sub pixel, and the first and second organic EL elements emitting lights of the same color, a light-extraction efficiency of the second sub pixel is larger than the light-extraction efficiency of the first sub pixel, and the driving method comprises steps of: supplying, from the reference voltage line drive circuit, the reference voltage to a gate of the drive transistor, controlling a light emitting level of the first organic EL element for gradation displaying, and controlling a light emitting period of the second organic EL element for gradation displaying.

The present invention uses a common pixel circuit configuration to change an input signal to drive an organic EL element contained in a sub pixel having high light-extraction efficiency by a digital gradation driving method. This configuration allows luminance unevenness to be suppressed and high display image quality to be provided. An organic EL element contained in a sub pixel having low light-extraction efficiency is driven by an analog gradation driving method. This configuration allows shading to be suppressed and high display image quality to be provided.

Further features of the present invention will become apparent from the following description of exemplary embodiments with reference to the attached drawings.

### BRIEF DESCRIPTION OF THE DRAWINGS

FIGS. 1A, 1B, and 1C are schematic views illustrating an organic EL panel, a pixel structure, and a pixel arrangement according to the present invention.

FIG. 2 is a graph illustrating a relation between the relative luminance and the view angle characteristics of an organic EL element according to the present invention.

FIG. 3 is a graph illustrating Vg-Id characteristics of the organic EL element according to the present invention.

FIGS. 4A, 4B, and 4C are schematic views illustrating the organic EL panel, the pixel structure, and the pixel arrangement of a first example.

FIG. 5 illustrates a pixel circuit of the first example.

FIG. 6 is an operation timing chart of the organic EL panel of the first example.

FIG. 7 illustrates a pixel circuit of a second example.

FIG. 8 is an operation timing chart of the organic EL panel of the second example.

### DESCRIPTION OF THE EMBODIMENTS

Preferred embodiments of the present invention will now be described in detail in accordance with the accompanying drawings.

Now, preferred embodiments of an organic EL display apparatus according to the present invention will be described referring to the accompanying drawings.

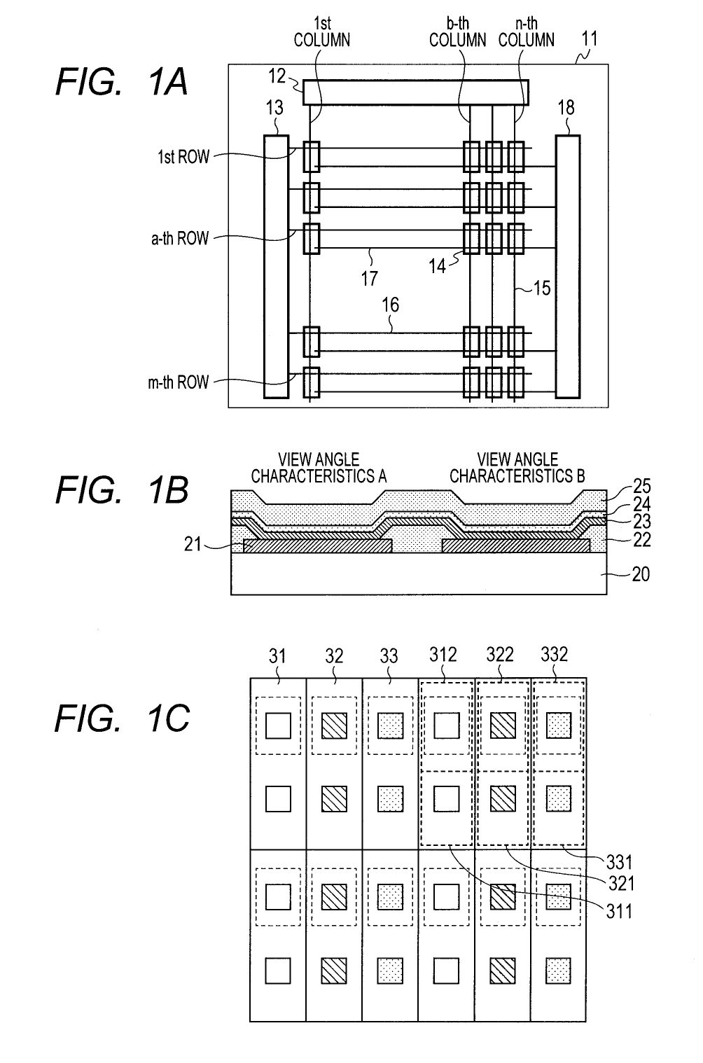

FIG. 1A a schematic view illustrating an organic EL panel 11 having a plurality of pixels (m-row×n-column pixels) arranged in a matrix, in which an organic EL element is arranged for each pixel. FIG. 1A is an example of the organic EL panel according to the present invention. The organic EL panel 11 includes a data line drive circuit 12 for applying a data signal to a data line 15; and a gate line drive circuit 13 for driving a gate line 16. The organic EL panel 11 further includes a pixel circuit 14 being arranged for each pixel, having a plurality of transistors, and supplying a drive current to the organic EL element in response to the data signal to turn on the organic EL element. The organic EL panel 11 further includes a reference voltage line drive circuit 18 for supplying a reference voltage signal to a reference voltage line 17. Each m-row n-column pixel is arranged at an intersection of each data line and each gate line and performs display based on a data signal corresponding to each pixel.

The data line drive circuit 12 is a data line driver for supplying a data signal corresponding to the image data to each pixel, and a circuit which receives image data from outside and controls a current flow for driving the organic EL element corresponding to the image data. The gate line drive circuit 13 is a gate line driver for driving each transistor of the pixel circuit 14 (driving the gate line 16 connected to a gate terminal of each transistor) and generates a pulse signal when a write operation is performed on the line. The gate line drive circuit 13 generally includes thereon a shift register and other logic circuits to perform a write operation sequentially from the first row and generates a logic signal to allow the pixel circuit 14 to perform a write operation. The pixel circuit 14 receives the data signal driven by the data line drive circuit 12 from the data line 15 and performs a write operation on the pixel in the write line specified by the gate line drive circuit 13.

The reference voltage line drive circuit 18 is a reference voltage line driver for supplying a reference voltage to a gate terminal of a transistor (drive transistor) supplying a drive current, from among a plurality of transistors. When the pixel emits light, the reference voltage line drive circuit 18 generates a specific reference voltage or a reference voltage signal such as a triangular wave and a sawtooth wave whose voltage changes as time elapses. The generated reference voltage signal is input to the pixel by the reference voltage line 17. When the sub pixel containing an organic EL element has low light-extraction efficiency, the reference voltage signal is a constant reference voltage. When the sub pixel containing an organic EL element has high light-extraction efficiency, the reference voltage signal is a signal such as a triangular wave and a sawtooth wave whose voltage changes as time elapses. In FIG. 1A, the reference voltage line 17 is connected to each pixel row by row, or may be connected to each pixel column by column, or may be shared with the data line 15. The reference voltage line drive circuit 18 may be shared with the data line drive circuit 12 and the gate line drive circuit 13.

FIG. 1B is a partial sectional view illustrating a portion corresponding to a pixel (for example, a-th row b-th column in FIG. 1A) of the display apparatus of the present invention. Each pixel of the display apparatus of the present invention includes a substrate 20 and a plurality of sub pixels being arranged in a matrix on the substrate 20 and forming a display region. Here, a “sub pixel” refers to a region having one light emitting element. FIG. 1B illustrates a top emission type display apparatus which emits light from an upper surface (from the upper direction) of an organic EL element formed on the substrate, but the present invention can be applied to a bottom emission type display apparatus.

The present invention provides each organic EL element as a light emitting element for each of the plurality of sub pixels. Specifically, each pixel has two organic EL elements emitting light of the same color. The two organic EL elements are a first organic EL element contained in a first sub pixel having a relatively low light-extraction efficiency and a second organic EL element contained in a second sub pixel having a relatively high light-extraction efficiency. Preferably, a high light condensing lens is provided on a light emitting side of the second organic EL element of the second sub pixel, and no lens is provided on a light emitting side of the first organic EL element of the first sub pixel. In this case, the optical characteristics of the first sub pixel having the lens are mutually different from the optical characteristics of the second sub pixel having no lens. Specifically, the view angle characteristics B of the first sub pixel have a wider view angle than that of the view angle characteristics A of the second sub pixel.

A region separation layer 22 for separating between light emitting regions is provided between each organic EL element in a different sub pixel. Each organic EL element includes a pair of an anode electrode 21 and a cathode electrode 24; and an organic compound layer 23 (hereinafter referred to as an “organic EL layer”) being sandwiched between the electrodes and containing a light emitting layer. Specifically, the substrate 20 has thereon an anode electrode 21 patterned for each element. The anode electrode 21 has thereon an organic EL layer 23. Further, the organic EL layer 23 has thereon a cathode electrode 24.

The anode electrode 21 is made of a conductive metal material having a high reflectance such as Ag. Alternatively, the anode electrode 21 may be made of a laminate with a layer made of such a metal material and a layer made of a transparent conductive material such as ITO (Indium-Tin-Oxide) excellent in hole injection characteristics.

The cathode electrode 24 is formed commonly to a plurality of organic EL elements and has a semi-reflective or light transmitting structure allowing light emitted by a light emitting layer to be extracted outside the element. Specifically, in a case in which the cathode electrode 24 is configured as a semi-reflective structure in order to improve the interference effect inside the element, the cathode electrode 24 is formed by forming a layer made of a conductive metal material such as Ag and AgMg having excellent electron injection characteristics with a film thickness of 2 to 50 nm. Note that the “semi-reflectivity” means a property that a part of light generated inside the element is reflected and a part thereof is transmitted and has a reflectance of 20% or more and less than 80% with respect to visible light. The “optical transmission” refers to a property having a transmittance of 80% or more with respect to visible light.

The organic EL layer 23 is made of a single layer or a plurality of layers including at least a light emitting layer. Example configurations of the organic EL layer 23 include a 4-layer configuration including a hole transport layer, a light emitting layer, an electron transport layer, and an electron injection layer; a 3-layer configuration including a hole transport layer, a light emitting layer, and an electron transport layer; and the like. The organic EL layer 23 may be made of well-known materials.

The substrate 20 has a pixel circuit formed so as to be able to independently drive each organic EL element. Each pixel circuit includes a plurality of thin-film transistors (hereinafter referred to as TFTs (Thin-Film-Transistors)) (unillustrated). The substrate 20 including the TFTs is covered with an interlayer insulating film (unillustrated) having a contact hole for electrically connecting the TFTs and the anode electrode 21. The interlayer insulating film has thereon a planarization film (unillustrated) for planarizing the surface by absorbing the surface asperities due to the pixel circuit.

The cathode electrode 24 has thereon a protection layer 25 formed to protect the organic EL layer 23 from oxygen and moisture in the air. The protection layer 25 is made of an inorganic material such as SiN and SiON. Alternatively, the protection layer 25 is made of a film laminated between an inorganic material and an organic material. The film thickness of the inorganic film is preferably 0.1 μm or more and 10 μm or less. The inorganic film is preferably made by a CVD process. The organic film is used to improve the protection capability by covering foreign matters that adhere to the surface and cannot be removed therefrom during the process and hence the film thickness of the organic film is preferably 1 μm or more. Note that in FIG. 1B, the protection layer 25 is formed along the shape of the pixel separation layer 22, but the protection layer 25 may have a flat surface. The use of an organic material allows the surface to be easily planarized.

The pixels of the display apparatus of the present invention may be configured as an organic EL panel having three different hues or may be configured as an organic EL panel having four different hues without being limited to the three hues. In the case of a 3-hue configuration, the pixels may be configured as an organic EL panel having three hues: R, G, and B and may be configured as organic EL elements having three hues: R, G, and B; or may be configured as white organic EL elements overlapped with color filters of three hues: R, G, and B. In the case of a 4-hue configuration, the pixels may be configured as an organic EL panel having four hues: R, G, B, and W. In a case in which the organic EL panel having three different hues is made of 3-hue organic EL elements, pixels emitting light of mutually different colors are preferably combined to form a pixel unit emitting light of three or more colors as a display unit.

FIG. 1C illustrates an example of a pixel arrangement of the organic EL panel of the present invention. The organic EL panel includes an R pixel 31, a G pixel 32, and a B pixel 33. The three pixels: the R pixel 31, the G pixel 32, and the B pixel 33 constitute a pixel unit of the organic EL panel. The present invention uses the pixel unit as a display unit. The R pixel 31 includes an R-1 sub pixel 311 and an R-2 sub pixel 312. Each sub pixel commonly has a hue of R and has mutually different optical characteristics. The G pixel 32 includes a G-1 sub pixel 321 and a G-2 sub pixel 322. Each sub pixel commonly has a hue of G and has mutually different optical characteristics. The B pixel 33 includes a B-1 sub pixel 331 and a B-2 sub pixel 332. Each sub pixel commonly has a hue of B and has mutually different optical characteristics. Each pixel includes two sub pixels having a hue of R and mutually different optical characteristics; two sub pixels having a hue of G and mutually different optical characteristics; and two sub pixels having a hue of B and mutually different optical characteristics.

Hereinafter, the R-1 sub pixel 311, the G-1 sub pixel 321, and the B-1 sub pixel 331 are assumed to be a first sub pixel having wide view-angle characteristics; and the R-2 sub pixel 312, the G-2 sub pixel 322, and the B-2 sub pixel 332 are assumed to be a second sub pixel having high light-extraction efficiency (front side luminance). Further, an organic EL element contained in the first sub pixel is assumed to be a first organic EL element; and an organic EL element contained in the second sub pixel is assumed to be a second organic EL element.

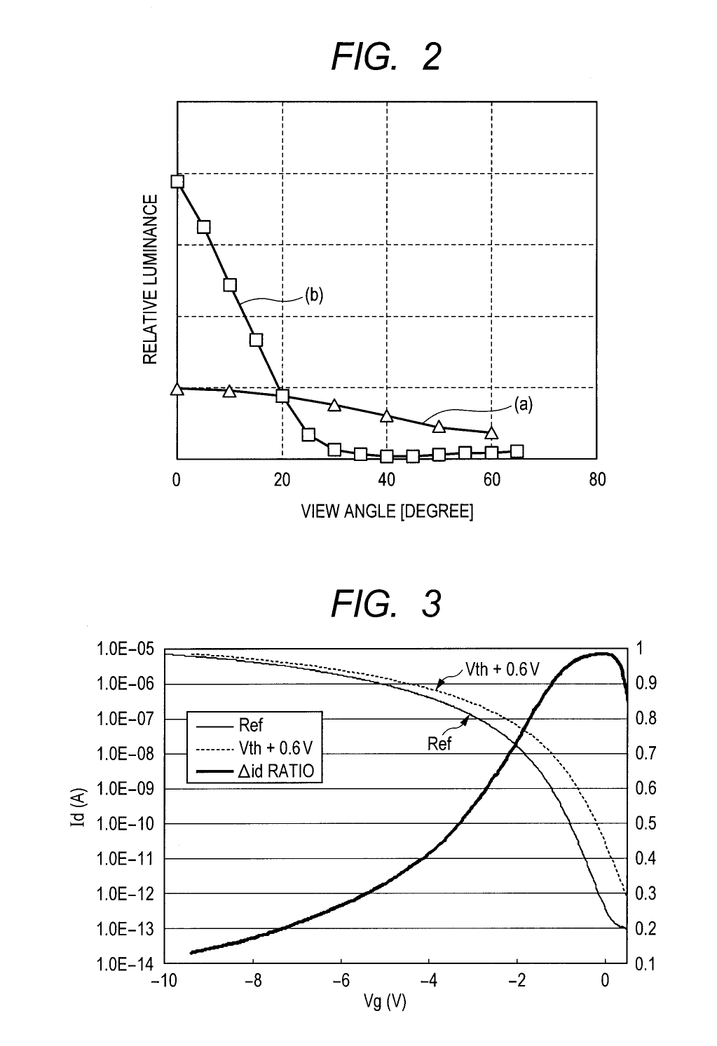

FIG. 2 is a graph illustrating a respective relation between the relative luminance and the view angle characteristics of the first sub pixel having a lens and the second sub pixel having no lens. In FIG. 2, (a) indicates the relation between the relative luminance and the view angle characteristics of the first sub pixel; and (b) indicates the relation between the relative luminance and the view angle characteristics of the second sub pixel. The luminance is represented by relative luminance values obtained when the same current is injected to the first organic EL element and the second organic EL element, and the front side luminance of the first sub pixel is assumed to be 1. From FIG. 2, the first sub pixel has a wide view angle. Meanwhile, the second sub pixel has a narrow view angle, but the front side luminance of the second sub pixel is about four times that of the first sub pixel. In short, the light-extraction efficiency of the first sub pixel is greater than the light-extraction efficiency of the second sub pixel.

Now, the operation of the organic EL panel 11 will be described. The two sub pixels of each pixel of R, G, and B having different optical characteristics are independently driven by a pixel circuit capable of selectively turning on and off (emitting light and not emitting light). For example, the R-1 sub pixel and the R-2 sub pixel of the R pixel can be independently turned on and off.

When only the R-1 sub pixel 311, the G-1 sub pixel 321, and the B-1 sub pixel 331 are turned on, the organic EL panel 11 can obtain a wide view angle performance (hereinafter referred to as a “wide view angle mode”).

When only the R-2 sub pixel 312, the G-2 sub pixel 322, and the B-2 sub pixel 332 are turned on at a low current and the front side luminance is set to the same luminance as when the R-1 sub pixel 311, the G-1 sub pixel 321, and the B-1 sub pixel 331 are turned on, power consumption can be reduced (hereinafter referred to as a “power save mode”).

In the above two modes of turning on only one of the first and second organic EL elements, the organic EL element contained in each sub pixel having a different light-extraction efficiency is driven by a different drive method. In the case of driving the second organic EL element contained in the second sub pixel having a relatively high light-extraction efficiency, the second organic EL element is driven by a drive method (hereinafter referred to as digital gradation driving) of performing gradation displaying by controlling the light emitting period. On the contrary, in the case of driving the first organic EL element contained in the first sub pixel having a relatively low light-extraction efficiency, the first organic EL element is driven by a drive method (hereinafter referred to as analog gradation driving) of performing gradation displaying by controlling the light emitting level. The image data is adjusted according to each drive method. Thus, the effect of the present invention can be obtained.

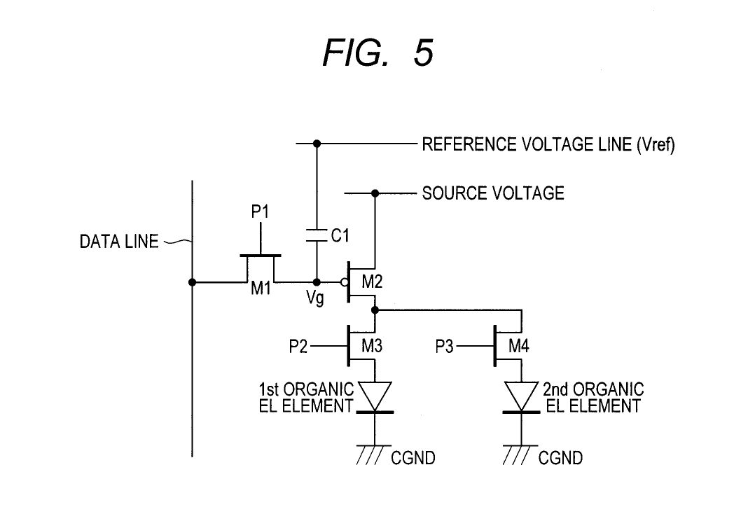

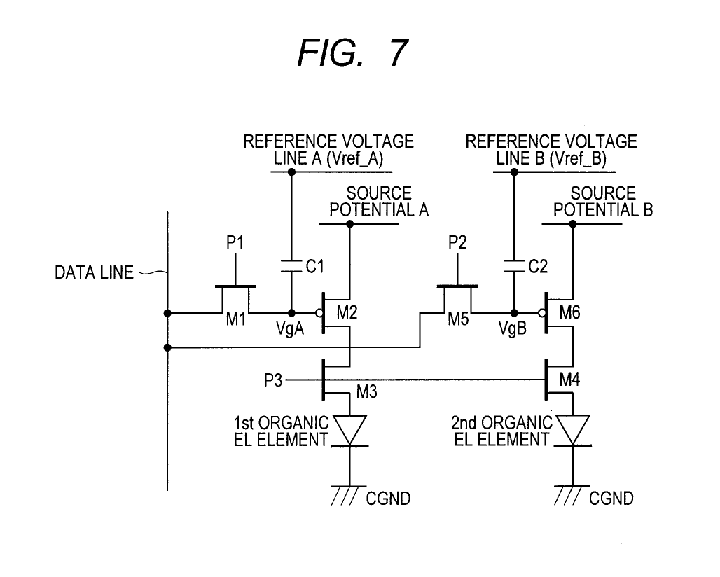

For example, the pixel circuit illustrated in FIGS. 5 and 7 are preferably used for the pixel circuit for driving in the two modes. The present invention has a reference voltage line driver having at least one drive transistor for each pixel and supplying a reference voltage to a gate terminal of the drive transistor so as to perform gradation display of the first organic EL element by controlling the light emitting level and to perform gradation display of the second organic EL element by controlling the light emitting period. Thus, the effect of the present invention can be obtained as described later. In the above two modes, only one of the first organic EL element and the second organic EL element is turned on, but the first organic EL element and the second organic EL element can be turned on at the same time to exert the effect of the present invention.

Next, the digital gradation driving and the analog gradation driving will be described.

In the digital gradation driving, the drive transistor for controlling the amount of current flowing through the organic EL element in the pixel is considered as a switch to perform ON/OFF binary control. The digital gradation driving is a drive method for gradation expression such that the length of the ON period, namely, the time to supply current to the organic EL element is changed to control the amount of current flowing through the organic EL element. This drive method performs switching operation of the drive transistor in a linear region, and thus has an advantage in being capable of suppressing current flow variations regardless of threshold characteristic variations commonly seen at manufacturing of LTPS-TFT. Specifically, the display apparatus can obtain uniform and high image quality with suppressed variation characteristics between each transistor. Unfortunately, the voltage applied to the drain terminal and the source terminal of the drive transistor is small, and hence the variations in the source voltage cannot be absorbed in the drive transistor, which causes variations in the voltage applied to the organic EL element. Thus, this drive method involves drive current variations and has a disadvantage of causing degradation of image quality as shading (intensity gradient).

In the analog gradation driving, the drive transistor is considered as an analog current source and a current according to the voltage applied to a gate electrode is applied to the organic EL element. Specifically, this drive method performs gradation expression by controlling the amount of current flowing through the organic EL element with the voltage level of the gate electrode. Note that changing the voltage level of the gate electrode means performing gradation display by controlling the light emitting level. This drive method drives the drive transistor in the saturation region, and hence the variations of the source voltage can be absorbed in the drive transistor. Thus, this drive method has an advantage in being capable of continuously injecting a constant amount of current in the organic EL element regardless of source voltage variations and drive voltage variations of the organic EL element itself. Unfortunately, threshold characteristic variations at manufacturing greatly change the amount of current supplied to the organic EL element. Specifically, the display apparatus has a disadvantage of causing rough display with remarkable variation characteristics between each transistor.

Recently, as the method of suppressing the transistor threshold variations, there have been proposed many methods including correcting the drive transistor threshold in the pixel and correcting the image data according to the transistor characteristics of each pixel. Although these correction methods can suppress the variations, the methods require the system to be complicated to completely eliminate the variations, and hence the methods are prohibitive. In particular, with the improvement in the light-extraction efficiency of the sub pixel, the smaller the drive current flowing through the organic EL element, the more remarkable the slight current variations.

FIG. 3 is a graph illustrating Vg-Id characteristics of two kinds of PMOS transistors. FIG. 3 illustrates the Ref characteristics of the two transistors and the characteristics with the threshold shifted by 0.6 V. The current difference ratio is defined as an Id ratio. As illustrated in FIG. 3, the larger the current Id, the smaller the current difference ratio; and the smaller the current Id, the larger the current difference ratio.

Thus, the digital gradation driving is preferable to uniformly drive the organic EL elements contained in the sub pixels having high light-extraction efficiency.

The present invention switches between the digital gradation driving and the analog gradation driving by switching between the image data and the reference voltage in the same pixel circuit according to the light-extraction efficiency of the sub pixel.

In the case of driving the second organic EL element contained in the second sub pixel having a high light-extraction efficiency, the digital gradation driving is performed to suppress the drive transistor variations. In this case, since the light-extraction efficiency is high, the required drive current is low. Thus, as illustrated in FIG. 3, the second organic EL element can be driven in a region less affected by the transistor characteristic variations. Further, source voltage drop due to power supply wiring resistance hardly occurs and shading is not remarkable.

In the case of driving the organic EL element contained in the sub pixel having a low light-extraction efficiency, the drive current is increased and shading is remarkable by source voltage drop due to power supply wiring resistance. In light of this, the analog gradation driving having a lower shading factor than that of the digital gradation driving is performed. Although the analog gradation driving involves luminance variations and unevenness due to characteristic variations of the drive transistor, the variations are hardly recognized because the drive current is large.

In order to switch between the digital gradation driving and the analog gradation driving, the input waveform of the reference voltage applied to the reference voltage line is switched. For digital gradation driving, a signal such as a triangular wave and a sawtooth wave whose voltage changes as time elapses is input so as to contain a voltage for operating the drive transistor in a linear region. For analog gradation driving, a specific voltage for driving the drive transistor in the saturation region is input.

Power is supplied from the power supply wiring to the first organic EL element and the second organic EL element. The source voltage applied to the power supply wiring for the digital gradation driving is preferably lower than that for the analog gradation driving. This is because it is easier to operate the drive transistor in a linear region and it is also possible to obtain the effect of suppressing the power consumption.

Hereinafter, the present invention will be described in detail by examples.

### First Example

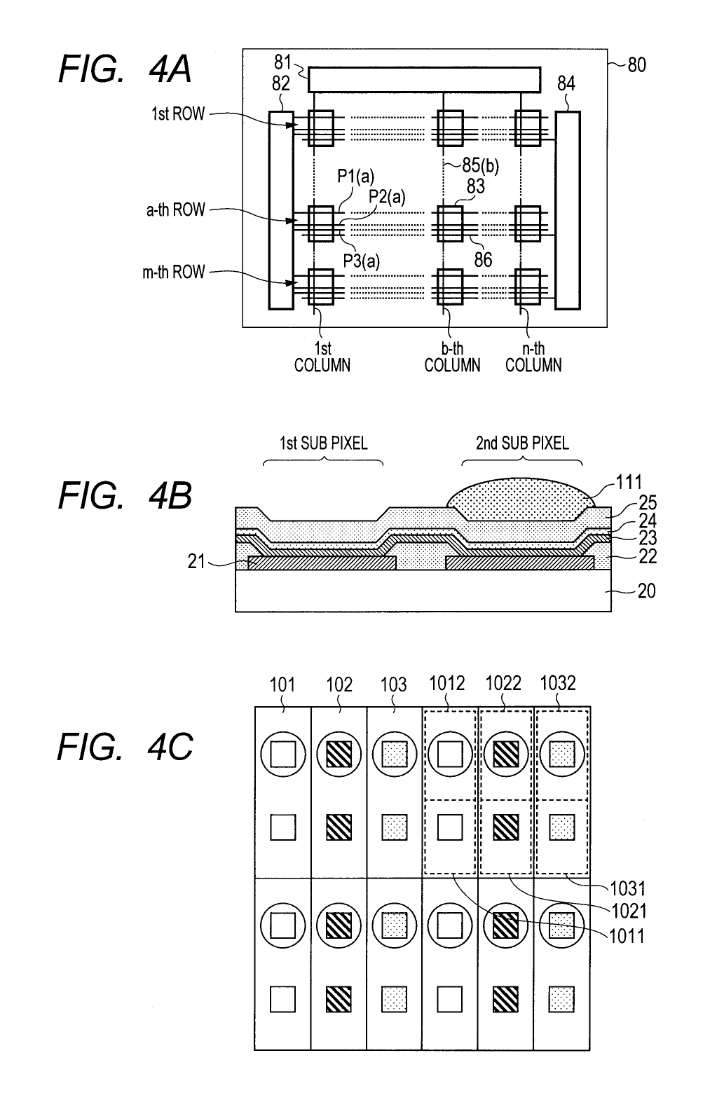

FIG. 4A is a schematic view illustrating an organic EL panel 80 having a plurality of pixels 83 (m-row×n-column pixels) arranged in a matrix and having an organic EL element arranged for each pixel. The organic EL panel 80 is the organic EL panel of the present example. The organic EL panel 80 includes unillustrated organic EL elements, a data line drive circuit 81 (data line driver), a gate line drive circuit 82 (gate line driver), a pixel circuit, and a reference voltage line drive circuit 84 (reference voltage line driver). The data line drive circuit 81 applies a data signal to a data line 85. The gate line drive circuit 82 drives gate lines P1 to P3. The pixel circuit is provided for each pixel 83, has a plurality of transistors, and supplies a drive current to an organic EL element according to the data signal to turn on the organic EL element. The reference voltage line drive circuit 84 applies a reference voltage signal to the reference voltage line 86. Each pixel includes two sub pixels emitting light of R and having different optical characteristics; two sub pixels emitting light of G and having different optical characteristics; and two sub pixels emitting light of B and having different optical characteristics. In FIG. 4A, the gate line drive circuit and the reference voltage line drive circuit 84 are arranged left and right respectively with the pixel group sandwiched therebetween, but one of the circuits may be arranged on one side of left and right sides, or a circuit having the same function may be arranged left and right to be driven from both sides so as to improve the quality of write operation to the pixel.

FIG. 4B is a partial sectional view illustrating a portion corresponding to a pixel of the display apparatus of the present example. The layers under the protection layer 25 are the same as illustrated in FIG. 1B. The first organic EL element has a flat surface, and the second organic EL element has thereon a lens 111. The lens 111 is formed by processing a resin material and specifically can be formed by a method such as embossing.

In the case of the first organic EL element of the first sub pixel having no lens, light emitted obliquely from a light emitting layer of the organic EL layer 23 is emitted further obliquely or fully reflected when emitted from the protection layer 25. Thus, the light cannot be extracted outside. Meanwhile, in the case of the second organic EL element of the second sub pixel having the lens 111, light emitted from a light emitting layer of the organic EL layer 23 is transmitted through a transparent cathode electrode 24, the protection layer 25, and the lens 111 in this order, and then is emitted outside.

When the lens 111 is present, the emission angle is closer to the normal direction of the substrate than when the lens is not present. Accordingly, when the lens 111 is present, the light condensing effect in the normal direction of the substrate is increased. Specifically, the display apparatus can increase the light use efficiency in the front direction. Further, when the lens 111 is present, the incident angle of the light emitted obliquely from the light emitting layer with respect to the emission interface is close to vertical, and hence the amount of fully reflected light is reduced. As a result, the light-extraction efficiency is increased.

Thus, the organic EL panel 80 of the present example includes a first sub pixel having a flat surface on the light emitting surface side of the organic EL element; and a second sub pixel having a lens on the light emitting surface side of the organic EL element (on a side of extracting light, namely, an upper side of a top emission type organic EL element). The first sub pixel has no lens and hence has the optical characteristic of having a wide view angle, and the second sub pixel has a lens and hence has the optical characteristic of having high light-extraction efficiency (front side luminance).

FIG. 4C illustrates a pixel arrangement of the organic EL panel of the present example. The organic EL panel includes an R pixel 101, a G pixel 102, and a B pixel 103. The three pixels of the R pixel 101, the G pixel 102, and the B pixel 103 constitute one pixel unit. The R pixel 101 has an R-1 sub pixel 1011 and an R-2 sub pixel 1012. The G pixel 102 has a G-1 sub pixel 1021 and a G-2 sub pixel 1022. The B pixel 103 has a B-1 sub pixel 1031 and a B-2 sub pixel 1032. The first organic EL element contained in the R-1 sub pixel 1011, the G-1 sub pixel 1021, and the B-1 sub pixel 1031 has a flat surface on the light emitting surface side thereof. The second organic EL element contained in the R-2 sub pixel 1012, the G-2 sub pixel 1022, and the B-2 sub pixel 1032 has thereon a lens on the light emitting surface side thereof. The R-1 sub pixel 1011, the G-1 sub pixel 1021, and the B-1 sub pixel 1031 have a relation between the relative luminance and the view angle characteristics as illustrated by (a) in FIG. 2; and the R-2 sub pixel 1012, the G-2 sub pixel 1022, and the B-2 sub pixel 1032 have a relation between the relative luminance and the view angle characteristics as illustrated by (b) in FIG. 2.

FIG. 5 illustrates a pixel circuit of the present example. A gate line P1 is connected to a gate terminal of TFT (M1). A selection gate line P2 of the first organic EL element is connected to a gate terminal of TFT (M3). A selection gate line P3 of the second organic EL element is connected to a gate terminal of TFT (M4). The data line is connected to a drain terminal of TFT (M1), and voltage data Vdata as a data signal is input from the data line. The anode electrode of the first organic EL element is connected to the source terminal of TFT (M3), and the cathode electrode thereof is connected to a ground voltage CGND. The anode electrode of the second organic EL element is connected to the source terminal of TFT (M4), and the cathode electrode thereof is connected to a ground voltage CGND. The drain terminal of TFT (M3) is connected to the drain terminal of TFT (M2), and the source terminal of TFT (M2) is connected to a source voltage. The drain terminal of TFT (M4) is connected to the drain terminal of TFT (M2). The source terminal of TFT (M1) is connected to one end of the capacitor C1 and the gate terminal of TFT (M2). The other end of the capacitor C1 is connected to the reference voltage line.

The present example selects and drives one of the first organic EL element and the second organic EL element of the same color. The analog gradation driving is performed when the first organic EL element contained in the first sub pixel having a relatively low light-extraction efficiency in the front direction is turned on. The digital gradation driving is performed when the second organic EL element contained in the second sub pixel having a relatively high light-extraction efficiency in the front direction is turned on. Specifically, a reference voltage is supplied to a gate terminal of the drive transistor of each pixel so as to perform gradation display of the first organic EL element by controlling the light emitting level and to perform gradation display of the second organic EL element by controlling the light emitting period. The gradation display is performed separately on the first organic EL element and the second organic EL element.

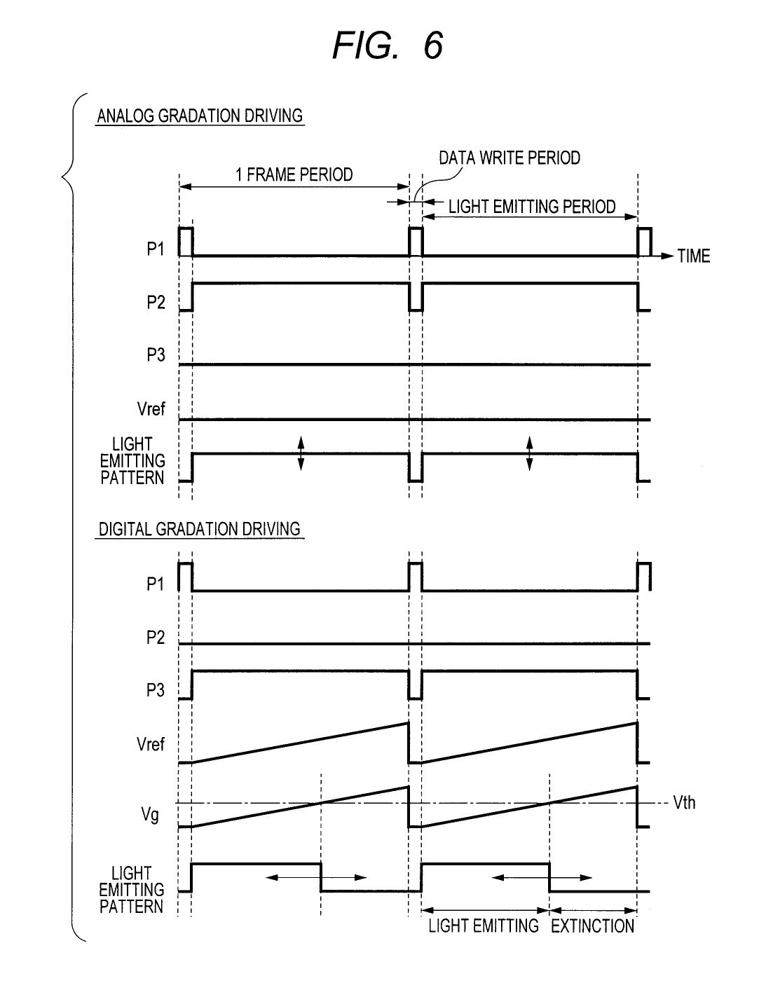

Next, the operation of the pixel circuit in FIG. 5 will be described using a timing chart in FIG. 6. In FIG. 6, the horizontal axis indicates time and the vertical axis indicates ON (HI) and OFF (LOW) of P1 to P3, Vref, Vg, and the light emitting pattern. P2 and P3 are signals responsible for light emission of the first organic EL element and the second organic EL element respectively.

First, the data write period will be described.

In this period, in any of the gradation driving methods, a HI-level signal is input to P1; a LOW-level signal is input to P2 and P3; M1 is turned ON; and M3 and M4 are turned OFF. At this time, M3 and M4 are not in a conducting state, and hence no current flows through the first and second organic EL elements. Vdata causes a voltage according to the current drive capability of M1 to occur in C1 interposed between the gate terminal of M2 and the supply voltage V1. Specifically, in any of the gradation driving methods, data signal is written (Vdata is input). The above description assumes that M1, M3, and M4 are nMOS, and M2 is pMOS. If M1, M3, and M4 are pMOS, the HI and LOW levels need to be reversed.

Next, the light emitting period will be described.

In the analog gradation driving, a LOW-level signal is input to P1, a HI-level signal is input to P2, and a LOW-level signal is input to P3; a constant signal is input to Vref; M1 is turned OFF; M3 is turned ON; and M4 is turned OFF. At this time, M3 is in a conducting state. Thus, the voltage of the image data applied to the gate electrode of M2 causes a current according to the current drive capability of M2 to be supplied to the first organic EL element. Then, the first organic EL element emits light at a luminance according to the supplied current. During the period when P2 is in HI-level, the first organic EL element emits light, and the time-averaged value in one frame period of the integrated light quantity is treated as the luminance of the first organic EL element.

In the digital gradation driving, a LOW-level signal is input to P1; a LOW-level signal is input to P2; a HI-level signal is input to P3; a triangular wave whose voltage increases with time within the light emitting period is input to Vref; M1 is turned OFF; M3 is turned OFF; and M4 is turned ON. At this time, M4 is in a conducting state. Thus, when Vref immediately after the data write operation is low, a data voltage is written to C1 so as to sufficiently turn on M2, and hence a current according to the current drive capability of M2 is supplied to the second organic EL element. The Vref voltage increases with time, and the voltage of the M2 gate electrode also increases. Since M2 operates in a linear region considered as a switching operation, a substantially constant current according to the current drive capability is continuously supplied to the second organic EL element. When the Vref voltage further increases, the voltage of the M2 gate electrode reaches an M2 threshold voltage (Vth). At this time, M2 enters an OFF state, and the current supplied to the second organic EL element is terminated.

The Vg voltage at a light emission start time is set based on the voltage written in the data write period. Accordingly, the period until Vg reaches Vth differs depending on the image data. Specifically, the light emitting period is controlled. Thus, the second organic EL element emits light at a substantially constant luminance during the period when a current is supplied, and the time-averaged value in one frame period of the integrated light quantity is treated as the luminance of the second organic EL element.

The same pixel circuit configuration for emitting light in this manner enables switching between the analog gradation driving and the digital gradation driving and selection of an optimum driving according to the light-extraction efficiency of the organic EL element, thus enabling suppression of luminance variations an unevenness and shading. Thus, high image quality can be provided.

The above description assumes that M2 is pMOS, but if M2 is nMOS, the same effect can be obtained by reversing the voltage change direction of the Vref voltage.

The source voltage for the digital gradation driving is preferably lower than that for the analog gradation driving. This is because it is easier to operate the TFT (M2) transistor in a linear region and it is also possible to obtain the effect of suppressing the power consumption.

### Second Example

In the first example, one of the first organic EL element and the second organic EL element is made to emit light, but in the present example, a plurality of reference voltage lines and drive transistors are provided to make the first organic EL element and the second organic EL element simultaneously emit light.

The organic EL panel of the present example is the same as that in FIGS. 4A to 4C, and the pixel structure and the pixel arrangement of the display apparatus of the present example are the same as those in FIGS. 4B and 4C. Thus, the description thereof will be omitted.

FIG. 7 illustrates the pixel circuit of the present example. The gate lines P1 and P2 are connected to the gate terminal of TFT (M1) and the gate terminal of TFT (M5) respectively. The selection gate line P3 for selecting the first organic EL element and the second organic EL element is connected to the gate terminal of TFT (M3) and the gate terminal of TFT (M4). The data line is connected to the drain terminal of TFT (M1) and the drain terminal of TFT (M5), and the voltage data Vdata as the data signal is input from the data line. The anode electrode of the first organic EL element is connected to the source terminal of TFT (M3), and the cathode electrode is connected to the ground voltage CGND. The anode electrode of the second organic EL element is connected to the source terminal of TFT (M4), and the cathode electrode is connected to the ground voltage CGND. The drain terminal of TFT (M3) is connected to the source terminal of TFT (M1), the drain terminal of TFT (M2), and one end of the capacitor C1. The source terminal of TFT (M2) is connected to the source voltage A. The drain terminal of TFT (M4) is connected to the source terminal of TFT (M5), the drain terminal of TFT (M6), and one end of the capacitor C2. The source terminal of TFT (M6) is connected to the source voltage B. The other end of the capacitor C1 is connected to the reference voltage line A, and the other end of the capacitor C2 is connected to the reference voltage line B.

The present example simultaneously selects and drives the first organic EL element and the second organic EL element of the same color. The analog gradation driving is performed when the first organic EL element contained in the first sub pixel having a relatively low light-extraction efficiency in the front direction is turned on. The digital gradation driving is performed when the second organic EL element contained in the second sub pixel having a relatively high light-extraction efficiency in the front direction is turned on. Specifically, a reference voltage is supplied to a gate terminal of the drive transistor of each pixel so as to perform gradation display of the first organic EL element by controlling the light emitting level and to perform gradation display of the second organic EL element by controlling the light emitting period. The gradation display is performed simultaneously on the first organic EL element and the second organic EL element.

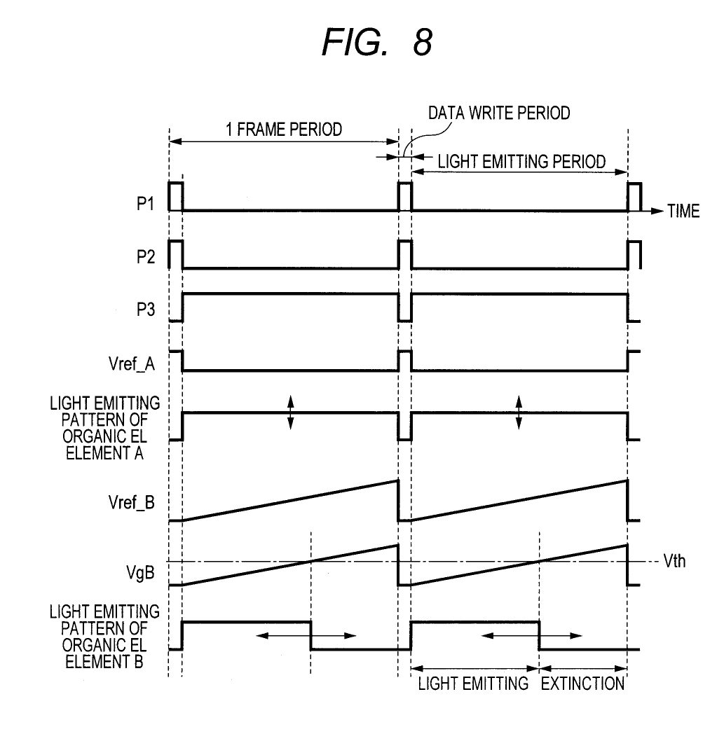

Next, the operation of the pixel circuit in FIG. 7 will be described using a timing chart in FIG. 8. In FIG. 8, the horizontal axis indicates time and the vertical axis indicates ON (HI) and OFF (LOW) of P1 to P3, Vref_A, Vref_B, Vg, and the light emitting pattern. P3 is a signal responsible for light emission of the first organic EL element and the second organic EL element.

First, the data write period will be described.

In this period, P1 and P2 are in a HI level; and P3 is in a LOW level. The same image data is written to both C1 and C2.

Next, the light emitting period will be described.

In this period, P1 and P2 are in a LOW level; and P3 is in a HI level. At the same time, the voltage of Vref_A is shifted and the voltage of VgA is set to a desired voltage. The voltage of Vref_B is gradually increased.

Thus, in the same manner as in the first example, the first organic EL element is subjected to analog gradation driving, and the second organic EL element is subjected to digital gradation driving to emit light.

The same pixel circuit configuration for emitting light in this manner enables switching between the analog gradation driving and the digital gradation driving and selection of an optimum driving according to the light-extraction efficiency of the organic EL element, thus enabling suppression of luminance variations and unevenness and shading. Thus, high image quality can be provided.

The above description assumes that M2 is pMOS, but if M2 is nMOS, the same effect can be obtained by reversing the voltage change direction of the Vref voltage.

The source voltage A may be the same as the source voltage B, but the source voltage B is preferably lower than the source voltage A. This is because it is easier to operate the TFT (M2) transistor in a linear region and it is also possible to obtain the effect of suppressing the power consumption.

Note that as a variation of the present example, the timing of turning on M1 and M2 during the data write period may be shifted to write different image data to C1 and C2. In this case, the light emitting period is such that the first organic EL element is turned on by the analog gradation driving and the second organic EL element is turned on by the digital gradation driving.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-269260, filed Dec. 2, 2010, which is hereby incorporated by reference herein in its entirety.

What is claimed is:

1. An organic EL display apparatus comprising:
a plurality of pixels arranged in a matrix, each of the pixels including first and second sub pixels, each of the sub-pixels including an organic EL element;
a data line drive circuit for supplying a data signal to the plurality of pixels;
a plurality of pixel circuits each arranged in each of the plurality of pixels, and each of the pixel circuits including a drive transistor for controlling a current supplied to the organic EL element based on the data signal; and
a reference voltage line drive circuit for supplying a reference voltage to the pixel circuit, wherein
each of the plurality of pixels includes a first organic EL element arranged in the first sub pixel and a second organic EL element arranged in the second sub pixel, and the first and second organic EL elements emitting lights of the same color, a light-extraction efficiency of the second sub pixel is larger than the light-extraction efficiency of the first sub pixel, and
the reference voltage line drive circuit supplies the reference voltage to a gate of the drive transistor, to control a light emitting level of the first organic EL element for gradation displaying, and to control a light emitting period of the second organic EL element for gradation displaying.

2. The organic EL display apparatus according to claim 1, wherein
the second sub pixel has a high light condensing lens at a light emitting side thereof, and
the first sub pixel has no high light condensing lens at a light emitting side thereof.

3. A driving method of an organic EL display apparatus comprising
a plurality of pixels arranged in a matrix, each of the pixels including first and second sub pixels, each of the sub-pixels including an organic EL element;
a data line drive circuit for supplying a data signal to the plurality of pixels;
a plurality of pixel circuits each arranged in each of the plurality of pixels, and each of the pixel circuits including a drive transistor for controlling a current supplied to the organic EL element based on the data signal; and
a reference voltage line drive circuit for supplying a reference voltage to the pixel circuit, wherein
each of the plurality of pixels includes a first organic EL element arranged in the first sub pixel and a second organic EL element arranged in the second sub pixel, and the first and second organic EL elements emitting lights of the same color, a light-extraction efficiency of the second sub pixel is larger than the light-extraction efficiency of the first sub pixel, and
the driving method comprising steps of:
supplying, from the reference voltage line drive circuit, the reference voltage to a gate of the drive transistor,
controlling a light emitting level of the first organic EL element for gradation displaying, and
controlling a light emitting period of the second organic EL element for gradation displaying.

4. The driving method according to claim 3, wherein
the step of supplying the reference voltage to the gate of the drive transistor includes
a step of supplying a constant reference voltage to the gate of the drive transistor for supplying a current to the first organic EL element, and
a step of supplying a reference voltage changing as a time elapses to the gate of the drive transistor for supplying a current to the second organic EL element.

5. The driving method according to claim 3, wherein
the organic EL display apparatus further includes a power source wiring for supplying a power to the first and second organic EL elements, and
a power source voltage applied to the power source wiring for supplying the power to the firs organic EL element is higher than a power source voltage applied to the power source wiring for supplying the power to the second organic EL element.
